(19) United States
(12) Patent Application Publication
(10) Pub. No.: US 2024/0430982 A1
(43) Pub. Date: Dec. 26, 2024

(54) Push-To-Talk Communication Over Two Different Communication Networks

(71) Applicant: STREAMWIDE, Paris (FR)

(72) Inventor: Soufien ABIDI, Tunis (TN)

(73) Assignee: STREAMWIDE, Paris (FR)

(21) Appl. No.: 18/748,785

(22) Filed: Jun. 20, 2024

(30) Foreign Application Priority Data
Jun. 23, 2023 (FR) 2306600

(51) Int. Cl. H04W 76/45

(52) U.S. Cl. CPC H04W 76/45

(57) ABSTRACT

Examples describe a method for push-to-talk communication between at least four communication terminals. Other examples also describe a terminal adapted to be connected to a communication accessory and a communication accessory adapted to be connected to two terminals of two different communication networks.

### CROSS-REFERENCE TO RELATED APPLICATION

This application claims priority under 35 USC § 119 and the Paris Convention to French Patent Application No. 2306600 filed on Jun. 23, 2023.

### FIELD OF THE DISCLOSURE

The present disclosure relates to the field of push-to-talk communications, or “PTT” (“Push-To-Talk”).

### BACKGROUND

Push-to-talk communications, also known as Press-to-transmit communications, are push-to-talk two-way type communications (not simultaneous) based on the actuation of a physical or virtual button by a user to switch from a reception mode into an emission mode and vice versa. These communications use half-duplex communication channels.

Push-to-talk communications are widely used, in particular by emergency services or by law-enforcement services in the context of their operations.

These communications may be improved.

### SUMMARY

In this respect, a method for push-to-talk communication between at least four communication terminals is provided;
at least one first communication terminal and a second communication terminal being adapted to exchange with each other data streams, corresponding to push-to-talk communications, on a first communication network using the Internet protocol;
a third communication terminal and at least one fourth communication terminal being adapted to exchange with each other data streams, corresponding to push-to-talk communications, on a second communication network using a protocol different from the Internet protocol;
the second terminal and the third terminal being further connected to the same communication accessory;
the method comprising:
   transmitting, by a fourth terminal, to the third terminal, a data stream of a push-to-talk communication, on a specific push-to-talk broadcast channel specific of the second network;
   transmitting, by the third terminal, to the accessory, an audio signal corresponding to the data stream of the push-to-talk communication;
   transmitting, by the accessory, to the second terminal, a signal indicating a start of data transmission and comprising an identifier of the specific push-to-talk broadcast channel of the second network;
   identifying, by the second terminal, a specific push-to-talk transmission channel of the first network associated with the specific push-to-talk broadcast channel of the second network, from the identifier of this channel;
   transmitting, by the accessory, to the second terminal, the audio signal corresponding to the data stream of the push-to-talk communication;
   transmitting, by the second terminal, to a first terminal, a data stream of a push-to-talk communication corresponding to the audio signal received from the accessory, on the specific push-to-talk transmission channel of the first network.

Optionally, the accessory comprises a microphone and a loudspeaker, and, prior to the transmission, by the accessory, to the second terminal, of the audio signal corresponding to the data stream of the push-to-talk communication, the method further comprises:
converting the audio signal corresponding to the data stream of the push-to-talk communication into an audible signal broadcasted by the loudspeaker of the accessory; then
converting the audible signal broadcasted by the loudspeaker and captured by the microphone of the accessory into an audio signal.

Optionally, the identifier of the specific push-to-talk broadcast channel of the second network corresponds to a frequency of the specific push-to-talk broadcast channel.

Optionally, the identification, by the second terminal, of the specific push-to-talk transmission channel of the first network associated with the specific push-to-talk broadcast channel of the second network, comprises:
selecting a specific push-to-talk transmission channel of the first network associated with the identifier of the specific push-to-talk broadcast channel of the second network in a pre-established look-up table.

The present disclosure further relates to another method for push-to-talk communication between at least four communication terminals;
at least one first communication terminal and a second communication terminal being adapted to exchange with each other data streams, corresponding to push-to-talk communications, on a first communication network using the Internet protocol;
a third communication terminal and at least one fourth communication terminal being adapted to exchange with each other data streams, corresponding to push-to-talk communications, on a second communication network using a protocol different from the Internet protocol;
the second terminal and the third terminal being further connected to the same communication accessory;
the method comprising:
   transmitting, by a first terminal, to the second terminal, a data stream of a push-to-talk communication on a specific push-to-talk transmission channel of the first network;
   identifying, by the second terminal, a specific push-to-talk broadcast channel of the second network associated with the specific push-to-talk transmission channel of the first network;
   transmitting, by the second terminal, to the accessory, a signal indicating a start of data transmission and comprising an identifier of the specific push-to-talk broadcast channel of the second network;
   transmitting, by the second terminal, to the accessory, an audio signal corresponding to the data stream of the push-to-talk communication;
   transmitting, by the accessory, to the third terminal, a signal indicating a start of data transmission on the specific push-to-talk broadcast channel of the second network;
   transmitting, by the accessory, to the third terminal, the audio signal corresponding to the data stream of the push-to-talk communication; and
   transmitting, by the third terminal, to the fourth terminal, a data stream of a push-to-talk communication corresponding to the audio signal received from the accessory, on the specific push-to-talk broadcast channel of the second network.

Moreover, the present disclosure relates to a push-to-talk communication terminal adapted to be connected to a communication accessory;

In first examples, the terminal is configured to perform first operations comprising:
after reception of a data transmission start signal, originating from the accessory, indicating a start of data transmission and comprising an identifier of a specific push-to-talk broadcast channel of a second network;
   identifying a specific push-to-talk transmission channel of a first network associated with the specific push-to-talk broadcast channel of the second network, from the identifier of the broadcast channel;
and after reception of an audio signal, originating from the accessory, corresponding to a push-to-talk communication emitted on the second network:
   sending a data stream on the identified specific push-to-talk transmission channel of the first network, the data stream corresponding to the audio signal received from the accessory.

Optionally, the first operations may further comprise at least one of the following operations:
selecting a specific push-to-talk transmission channel of the first network associated with the identifier of the specific push-to-talk broadcast channel of the second network in a pre-established look-up table;
sending a signal indicating a start of transmission on the determined specific push-to-talk transmission channel of the first network; or
sending a signal indicating an end of transmission on the specific push-to-talk transmission channel, when the audio signal of the push-to-talk communication is completed;

In second examples, the terminal is configured to perform second operations comprising:
after reception of a data stream of a push-to-talk communication on a specific transmission channel of a first network:
   identifying a specific push-to-talk broadcast channel of the second network associated with the specific push-to-talk transmission channel of the first network;
   sending, to the accessory, a signal indicating a start of data transmission and comprising an identifier of the specific push-to-talk broadcast channel of the second network; and
sending, to the accessory, an audio signal corresponding to the data stream of the push-to-talk communication received on the specific transmission channel of the first network.

Optionally, the second operations may further comprise the following operation:
selecting a specific push-to-talk broadcast channel of the second network associated with the specific push-to-talk transmission channel of the first network in a pre-established look-up table.

Optionally, the terminal is configured to perform the first and second operations.

The present disclosure also relates to a communication accessory adapted to be connected to a communication terminal of a first communication network and to a communication terminal of a second communication network, the communication terminal of the first network being configured to exchange data streams, corresponding to push-to-talk communications, on a first communication network using the Internet protocol.

In first examples, the accessory is configured to perform the following operation:
after reception of an audio signal corresponding to a data stream of a push-to-talk communication emitted on the specific broadcast channel of the second network, originating from the communication terminal of the second network:
sending, to the communication terminal of the first network, a signal indicating a start of data transmission and comprising an identifier of the specific push-to-talk broadcast channel of the second network.

In second examples, the accessory is configured to perform the following operation:
after reception of a signal indicating a start of data transmission and comprising an identifier of the specific push-to-talk broadcast channel of the second network, originating from the communication terminal of the first network:
   sending, to the communication terminal of the second network, a signal indicating a start of data transmission and comprising an identifier of the specific push-to-talk broadcast channel of the second network.

Optionally, the accessory is configured to perform the following operation:
after reception of an audio signal corresponding to a data stream of a push-to-talk communication emitted on the specific broadcast channel of the second network, originating from the communication terminal of the second network:
   sending, to the communication terminal of the first network, a signal indicating a start of data transmission and comprising an identifier of the specific push-to-talk broadcast channel of the second network;
and the accessory is further configured to perform the following operation:
after reception of a signal indicating a start of data transmission and comprising an identifier of the specific push-to-talk broadcast channel of the second network, originating from the communication terminal of the first network:
   sending, to the communication terminal of the second network, a signal indicating a start of data transmission and comprising an identifier of the specific push-to-talk broadcast channel of the second network.

The Application further relates to a computer program product including instruction for the implementation of any one of the method disclosed by the present disclosure when this program is executed by at least one processor.

Finally, the Application relates to a computer-readable non-transitory storage medium on which a program is stored for the implementation of any one of the methods disclosed by the present disclosure when this program is executed by at least one processor.

Thus, the present disclosure, according its different variants, enables two groups of push-to-talk communication terminals, belonging to different communication networks, to communicate together, so that, from the perspective of the users of the terminals of the two communication groups, there is one single communication group. In particular, the electronic architectures and networks of the terminals have not been modified to enable the implementation of this solution. The configurations of a terminal and of a communication accessory of the communication system may be modified and are enough to enable this operation, so that the proposed solution is inexpensive and barely complex to implement. In particular, existing terminals may be used without it being necessary to adapt them, neither structurally nor functionally.

### DETAILED DESCRIPTION OF THE DISCLOSURE

Other features, details and advantages will appear upon reading the detailed description hereinafter, and on analysis of the appended drawings, wherein:

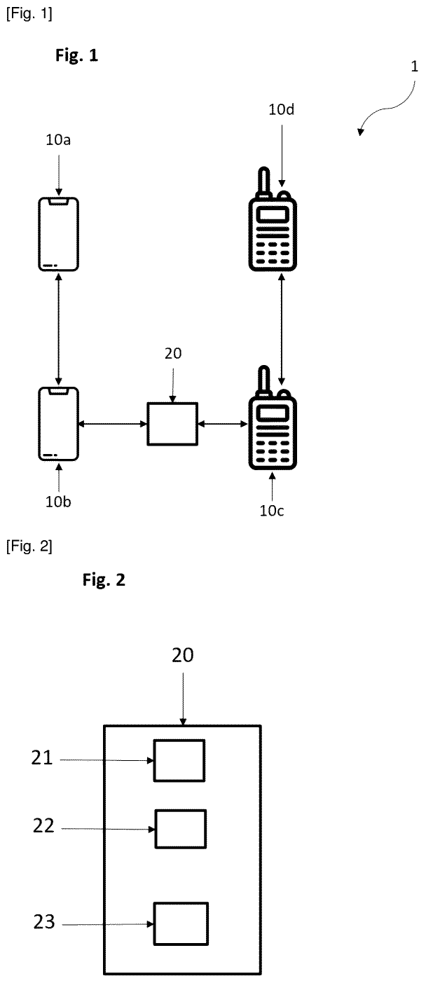

FIG. 1 schematically shows an example of a communication system.

FIG. 2 schematically shows an example of an accessory according to the present disclosure.

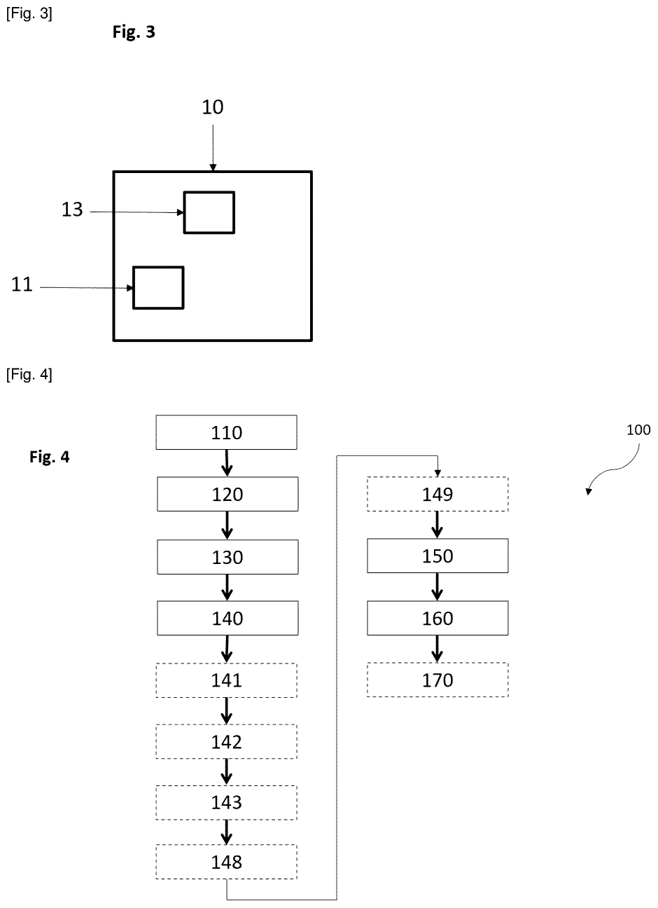

FIG. 3 schematically shows an example of a terminal according to the present disclosure.

FIG. 4 schematically shows an example of a method for push-to-talk communication between at least four communication terminals.

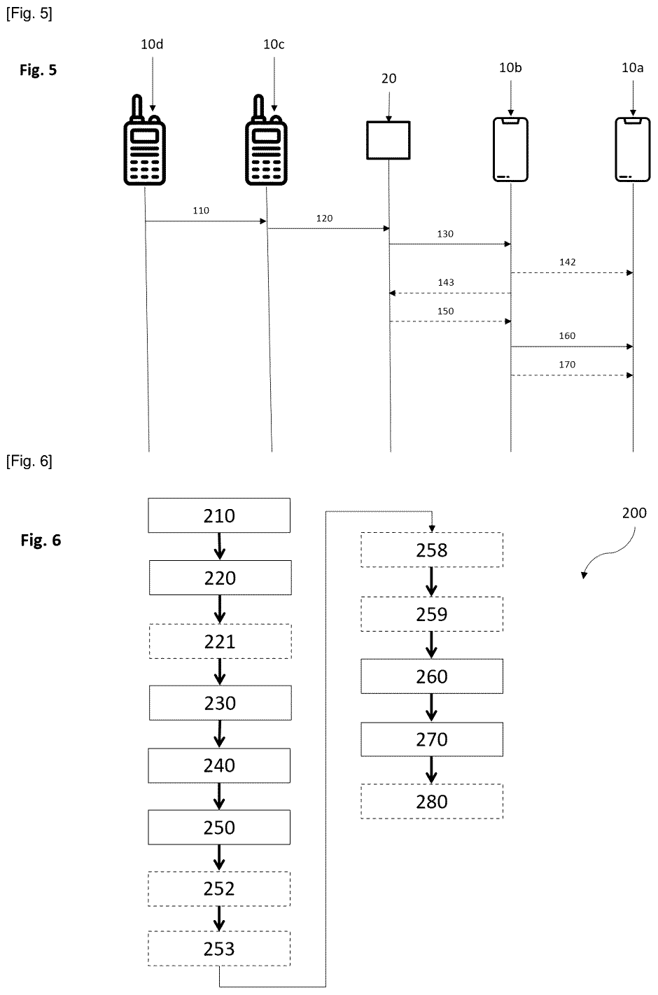

FIG. 5 schematically shows a communication diagram of the example of a method for push-to-talk communication between at least four communication terminals illustrated in FIG. 4.

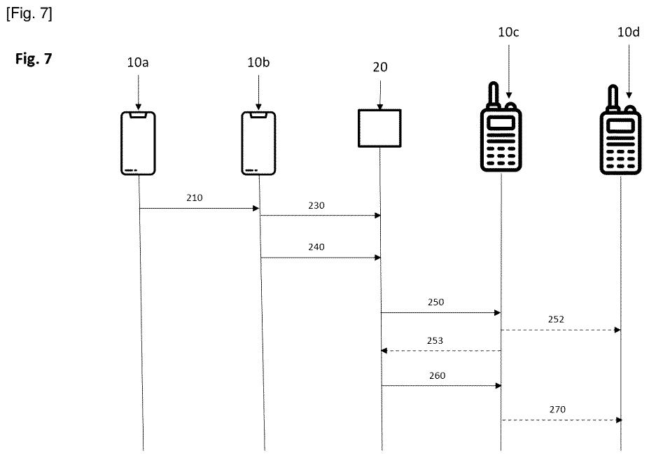

FIG. 6 schematically shows another example of a method for push-to-talk communication between at least four communication terminals.

FIG. 7 schematically shows a communication diagram of the example of a method for push-to-talk communication between at least four communication terminals illustrated in FIG. 6.

### DESCRIPTION OF THE EMBODIMENTS

An example of a communication system 1 is now described with reference to FIG. 1 wherein a push-to-talk communication method, a first example of which is described with reference to FIG. 4 and a second example of which is described with reference to FIG. 6, may be implemented. The system 1 enables a data stream exchange, corresponding to push-to-talk communications, between communication terminals in particular using a communication accessory.

By “communication terminal” or “terminal”, the present disclosure refers to a communication device configured to communicate with other communication terminals on a communication network. Hence, a “push-to-talk communication terminal” refers to a communication terminal configured to implement push-to-talk communications.

For example, a communication terminal may correspond to a computer, a telephone, a walkie-talkie. Thus, a communication terminal may correspond to a stationary device, such as a personal computer, or a mobile device, such as a mobile phone.

By “communication network”, or “network”, the present disclosure refers to an interconnected system enabling data exchange between different devices belonging to the network.

By “data stream”, or “stream”, the present disclosure refers to at least two successive data packets.

By “push-to-talk communication”, the present Application refers to non-simultaneous two-way type communications based on the actuation of a physical or virtual button by a user, or an equivalent computer command, to switch from a reception mode into an emission mode. These push-to-talk communications, or Press-to-transmit (hereinafter PTT), use half-duplex communication channels. These half-duplex communication channels are so-called push-to-talk transmission channels, push-to-talk broadcast channels or push-to-talk communication channels. In particular, in the present disclosure, reference will be made to a push-to-talk transmission channel when it consists of a communication channel using a first communication network while reference will be made to a push-to-talk broadcast channel when it consists of a communication channel using a second communication network. The first and second communication networks will be detailed later on.

The Inventors have noticed that the agents having to use push-to-talk communication channels to communicate and coordinate themselves, do not always have access to communication terminals allowing communicating on the network on which the push-to-talk communication channels are open. Thus, a considered agent may have access to a specific terminal allowing communicating on a first communication network, while the communication channel on which he/she wishes to communicate is open on a second communication network, different from the first one. Consequently, the specific communication terminal of the operator does not enable him/her to communicate on this communication channel.

The system 1 according to the present disclosure proposes a solution to this problem by creating a communication gateway between two push-to-talk communication channels belonging to two different communication networks. In this manner, a user of a communication terminal communicating on an open communication channel on a first communication network, also communicates on an open communication channel on a second communication network. As detailed hereinafter, the system 1 proposes using a communication accessory, connected to both a communication terminal of the first network, and to a communication terminal of the second network, to transmit the push-to-talk communications from one network to another. The accessory acts as a relay between the two communication channels and also transfers different signals relating to talk management between the participating communication terminals of the two communication channels.

The system 1 comprises at least four communication terminals, referenced 10a to 10d in FIG. 1.

Among these at least four communication terminals, at least one first terminal 10a and a second terminal 10b are configured to exchange with each other data streams, corresponding to push-to-talk communications, on a first network using the Internet protocol. In particular, the Internet protocol is defined in the standard RFC 791. A network using the Internet protocol is generally so-called “IP network”, well-known to a person skilled in the art. The at least one first terminal 10a and the second terminal 10b form a first group of communication terminals configured to exchange push-to-talk communications with each other on the first network.

Among these at least four communication terminals, a third terminal 10c and at least one fourth terminal 10d are configured to exchange with each other data streams, corresponding to push-to-talk communications, on a second network using a protocol different from the Internet protocol. In some examples, the second network may correspond to a network using a radio protocol. For example, the radio protocol may correspond to a Digital Mobile Radio (DMR) protocol. In particular, the digital mobile radio protocol is defined in the standard TS 102 361 of the ETSI (European Telecommunications Standards Institute), in particular in parts 1 to 4. In the same way as for the Internet protocol, the mobile radio protocol (DMR) is well-known to a person skilled in the art. The third terminal 10c and the at least one fourth terminal 10d form a second group of communication terminals configured to exchange push-to-talk communications with each other on the second network distinct from the first one.

Thus, the described communication system 1 comprises at least four terminals, decomposed into two groups of terminals each including at least two different terminals. Each of the groups of terminals is configured to exchange data streams, corresponding to push-to-talk communications, on a respective network. In the example of FIG. 1, each of the groups of communication terminals comprises two terminals, but it should be understood that each of these groups may comprise more.

The communication system 1 further comprises a communication accessory 20. The communication accessory 20 is connected, on the one hand, to a terminal adapted to exchange data streams on the first network and, on the other hand, to another terminal adapted to exchange data stream on the second network. In the example of FIG. 1, the communication accessory 20 is connected to both the second terminal 10b and the third terminal 10c.

In the present application, a communication accessory refers to a device distinct from the communication terminals and adapted to exchange analog or digital audio signals with at least one communication terminal to which it is connected.

Consequently, a shared communication protocol is set up between a specific terminal and the communication accessory 20 when the specific terminal and the communication accessory 20 are connected.

The communication accessory 20 may also be adapted to:
1) convert an audible signal into an analog or digital audio signal; and
2) convert an analog or digital audio signal into an audible signal.

In some examples, a communication accessory 20 may, for example, correspond to a combination of a microphone and a loudspeaker remote from each other. Visually speaking, the communication accessory may look like a “handheld-type speaker microphone”, i.e. a light, small-sized case, generally carried at the level of the chest or the shoulder of the user and connected by a cable to a terminal generally more bulky, heavier and carried at the belt.

In some examples, the communication accessory 20 may comprise a microphone 21 adapted to convert an audible signal into an analog or digital audio signal.

In some examples, the accessory 20 may comprise a loudspeaker 22 adapted to convert an analog or digital audio signal into an audible signal.

In some examples, the communication accessory 20 may comprise a connection interface 23 enabling connection thereof to at least one communication terminal 10.

In some examples, the connection interface 23 may, for example, comprise a wireless interface configured to handle a wireless communication protocol, for example a Bluetooth communication protocol, or a Bluetooth Low Energy (BLE) communication protocol. In particular, the Bluetooth and Bluetooth Low Energy communication protocol are defined in the standard IEEE 802.15.4.

In some examples, the connection interface 23 may, for example, comprise a wired interface configured to handle a wired communication protocol, for example a universal series bus (“Universal Series Bus”) communication protocol, generally so-called USB protocol.

An exemplary accessory comprising a microphone 21, a loudspeaker 22 and a connection interface 23 is schematically shown in FIG. 2.

In the examples shown in FIG. 1 wherein the accessory 20 is connected to one or more terminal(s), for example when it is connected to the second 10b and third 10c terminals, the concerned terminal(s) may also comprise a connection interface 13 allowing establishing a connection with the connection interface 23 of the accessory and thus connecting to the accessory 20. In these examples, a shared communication protocol is implemented between the accessory 20 and a terminal 10 to which it is connected.

In some examples, the connection interface 13 of one terminal may comprise a wireless interface configured to handle a wireless communication protocol, for example a Bluetooth communication protocol, or a Bluetooth Low Energy (BLE) communication protocol.

In some examples, the connection interface 13 of one terminal may comprise a wired interface configured to handle a wired communication protocol, for example a universal series bus communication protocol.

In some examples, a terminal 10, and in particular the second terminal 10b, may comprise a memory 11 configured to store a look-up table between push-to-talk transmission channels of the first network, and push-to-talk broadcast channels of a second network. These examples will be detailed later on.

An example of a communication terminal 10 comprising a memory 11 and a connection interface 13 is schematically shown in FIG. 3.

The described system 1 enables communication of two groups of push-to-talk terminals belonging to two different networks in a simple manner, without requiring modifying the electronic architecture of the terminals, i.e. without any modification of the hardware of the terminals. More specifically, the described system 1 allows associating two push-to-talk communication groups belonging to two different, and a priori incompatible, networks, to form the same communication group, in a transparent manner for the users while solving the specific problems related to voice management of the push-to-talk communications. In particular, when a user of a communication terminal belonging to a communication group on a first network talks, the users of the communication terminals belonging to the other communication group on the second network cannot talk. Thus, the transmission of the data stream to the two groups of terminals is reserved to the user of the first group until the end of his/her data transmission. This is possible by the clever use of the communication accessory, connected to both a terminal of the first network, and a terminal of the second network, which acts as a relay by transmitting signals indicating a start of data transmission (i.e. signals indicating a start of talk) from one network to another.

Henceforth, referring to FIG. 4, an example of a method 100 for push-to-talk communication between at least four communication terminals is described. This consists of a method for communication between the communication terminals 10a, 10b, 10c, 10d of the exemplary system 1 described hereinbefore and distributed into two groups. Thus, the accessory 20 is connected to both the second terminal 10b and the third terminal 10c. A communication diagram illustrating different operations of the method 100 is also schematically illustrated in FIG. 5 in order to facilitate understanding of the method 100 described with reference to FIG. 4.

Moreover, it should be noted that FIG. 4 is just an illustration of the exemplary method 100 illustrating, by blocks, the different operations possibly included in the method and described later on. In this respect, and unless stated otherwise, this illustration does not reflect any sequentiality between the operations. In other words, the operations described with reference to FIG. 4 are not necessarily implemented after one another and may be implemented in an order different from that one shown in FIG. 4. Moreover, an operation of the method 100 may be implemented several times before the implementation of another operation of the method 100. Thus, unless stated otherwise, the frequency of implementation of each operation of the method 100 is specific thereto and is not necessarily related to the implementation of the other operations.

As illustrated in FIG. 4, the method 100 comprises an operation 110 of transmitting, by the fourth terminal 10d, to the third terminal 10c, a data stream of a push-to-talk communication. This push-to-talk communication is performed on a specific broadcast channel of the second communication network.

As illustrated in FIG. 4, the method 100 comprises an operation 120 of transmitting an audio signal, by the third terminal 10c, to the accessory 20. The audio signal corresponds to the data stream of the push-to-talk communication sent by the fourth terminal 10d to the third terminal 10c formatted so as to be readable by the communication accessory 20. The audio signal is sent in accordance with the shared connection protocol between the third terminal 10c and the accessory 20 for connection thereof.

As illustrated in FIG. 4, the method 100 comprises an operation 130 of transmitting, by the accessory 20, to the second terminal 10b, a signal indicating a start of data transmission and comprising an identifier of the specific push-to-talk broadcast channel of the second network. In this operation 130, the accessory 20 indicates to the second terminal 10b that there is a communication on a specific broadcast channel of the second network.

In some examples, the identifier of the specific push-to-talk broadcast channel of the second network may correspond to a frequency of the specific push-to-talk broadcast channel. In particular, when the second network uses a radio protocol, the identifier may correspond to a frequency of the radio protocol of the specific push-to-talk broadcast channel, for example at the carrier frequency of the specific push-to-talk broadcast channel.

As illustrated in FIG. 4, the method 100 comprises an operation 140 of identifying, by the second terminal 10b, a specific push-to-talk transmission channel of the first network associated with the specific push-to-talk broadcast channel of the second network, from the identifier of this channel. In this operation 140, the second terminal 10b links the specific broadcast channel of the second network and a specific transmission channel corresponding to the first network.

As illustrated in FIG. 4, the method 100 comprises an operation 150 of transmitting, by the accessory 20, to the second terminal 10b, the audio signal corresponding to the data stream of the push-to-talk communication emitted on the second network. Thus, the accessory 20 transmits an audio signal corresponding to the push-to-talk communication sent by the fourth terminal 10d to the third terminal 10c using the second network, to the second terminal 10b using the first network.

As illustrated in FIG. 4, the method 100 comprises an operation 160 of transmitting, by the second terminal 10b, to the first terminal 10a, a data stream of a push-to-talk communication corresponding to the audio signal received from the accessory 20. This data stream is emitted on the specific push-to-talk transmission channel of the first network.

Consequently, the method 100 according to the present disclosure enables a user emitting a push-to-talk communication on a communication channel of a communication network other than the IP network to communicate with communication terminals connected to a corresponding communication channel of the IP network, while ensuring management of talks between the users specific to push-to-talk communications. It should be recalled that in push-to-talk communications, when one terminal communicates on a specific channel, the other terminals connected to the specific channel cannot emit.

Optionally, other operations may be integrated into the method 100 and are described later on in the present disclosure. Unless stated otherwise, these operations may be integrated into the method 100 in combination with one another.

In some examples, the operation 140 of identifying, by the second terminal 10b, the specific push-to-talk transmission channel of the first network associated with the specific push-to-talk broadcast channel of the second network, may comprise:
selecting 141 a specific push-to-talk transmission channel of the first network associated with the identifier of the specific push-to-talk broadcast channel of the second network in a pre-established look-up table.

In these examples, the second terminal 10b may have a memory 11 configured to store the look-up table associating push-to-talk transmission channels of the first network with identifiers of push-to-talk broadcast channels of the second network. Thus, after reception of an identifier of a push-to-talk broadcast channel of the second network, the second terminal 10b can identify to which transmission channel of the first network this identifier corresponds. Hence, it will be capable of transmitting the audio signal of the push-to-talk communication, received from the accessory 20, on the corresponding channel of the first network.

In some examples, subsequently to the operation 140 of identifying the specific push-to-talk transmission channel, the method may further comprise:
an operation 142 of transmitting, by the second terminal 10b, a signal indicating a start of transmission on the specific push-to-talk transmission channel of the first network.

The operation 142 allows reserving the specific channel of the first network in transmission for the second terminal 2b. To the extent that it is sent on the specific push-to-talk transmission channel of the first network, this signal is transmitted in particular to the first terminal 10a, as shown in FIG. 5.

In some examples wherein the accessory 20 comprises a microphone 21 and a loudspeaker 22, prior to the operation 150 of transmitting the audio signal from the accessory 20 to the second terminal 10b, the method 100 may further comprise:
an operation 148 of converting the audio signal corresponding to the data stream of the push-to-talk communication into an audible signal broadcasted by the loudspeaker of the accessory 20; then
an operation 149 of converting the audible signal broadcasted by the loudspeaker 22 and captured by the microphone 21 of the accessory 20 into an audio signal.

In these examples, this consists in transmitting the audible signal of the push-to-talk communication broadcast at first on the second network to the first network by ingeniously using the accessory 20 connected to the two networks as a broadcaster of the push-to-talk communication via its loudspeaker 22, for the user of the accessory 20, and as a recorder of the push-to-talk communication broadcasted by the loudspeaker 22 via the microphone 21 for the users of the first network. Thus, from the perspective of a user of the first terminal 10a, when a user of the fourth terminal 10d talks on the specific broadcast channel of the second network, he/she hears talking of the user of the fourth terminal 10d on the corresponding specific transmission channel of the first network, but this talking is transmitted to him/her via the second terminal 10b also connected to the specific transmission channel, and that being so in a completely transparent manner. More generally, each user of a terminal connected to the specific broadcast channel of the first network or to the specific transmission channel of the second network hears the user of the fourth terminal 10d in a transparent manner and cannot talk since each of these channels is reserved to him/her according to the push-to-talk communication principle.

In the examples comprising the operations 148 and 149, prior to the conversion operation 149, and subsequently to the operation 140 of identifying the specific push-to-talk transmission channel, the method may further comprise the following operation:
an operation 143 of transmitting, by the second terminal 10b, to the accessory, a command for activating the microphone 21.
   The operation 143 allows notifying the accessory 20 that the microphone 21 should be used to capture and then transmit the sound on the specific transmission channel of the first network.

In examples wherein the method 100 comprises the operation 142, the operation 143 is advantageously implemented after step 142 so that a message that the microphone 21 of the accessory 20 starts recording, i.e. from the push-to-talk communication emitted on the second network and broadcasted by the loudspeaker 22, could be directly transmitted on the specific push-to-talk transmission channel of the first network.

In some examples, the method 100 may further comprise an operation 170 of transmitting, by the second terminal 10b, a signal indicating an end of transmission on the specific push-to-talk transmission channel, when the audio signal of the push-to-talk communication is completed. To the extent that it is sent on the specific push-to-talk transmission channel of the first network, this signal is transmitted in particular to the first terminal 10a, as shown in FIG. 5. The operation 170 allows clearing the specific push-to-talk transmission channel in transmission to enable other users of the specific push-to-talk transmission channel, in particular the user of the first terminal 1a in the exemplary system 1, to talk on this channel.

Of course, the described operations of the method 100 are imagined to be executed in real-time so that, as soon as the user of the fourth terminal 10d talks on the specific broadcast channel of the second network, the transmission start signal may be transmitted, almost simultaneously, from the accessory 20 to the second terminal 10b which could reserve the specific transmission channel of the first network for talking of the user of the fourth terminal 10d.

Henceforth, referring to FIG. 6, another example of a method 200 for push-to-talk communication between at least four communication terminals is described. This consists of a mirrored method with respect to that one described with reference to FIG. 4, the push-to-talk communication being this time transmitted from the IP first communication network towards the second communication network. Consequently, it also consists of a method for communication between the communication terminals 10a, 10b, 10c, 10d of the exemplary system 1 with the accessory 20 connected to both the second terminal 10b and the third terminal 10c. For concision, the elements which have been described with reference to the method 100 of FIG. 4, and which are used again in the method 200 of FIG. 6, will not be described once again. A communication diagram illustrating the different operations of the method 200 is schematically illustrated in FIG. 7 in order to facilitate understanding of the method schematically illustrated in FIG. 6.

Moreover, it should be noted that FIG. 6 is just an illustration of the exemplary method 200 illustrating, by blocks, the different operations possibly included in the method and described later on in the document. In this respect, this illustration does not reflect any sequentiality between the operations except when such a sequentiality is explicitly stated by the present disclosure. In other words, the operations described with reference to FIG. 6 are not necessarily implemented after one another and may be implemented in an order different from that one shown in FIG. 6. Moreover, one operation of the method 200 may be implemented several times before implementation of another operation of the method 200. Thus, unless stated otherwise, the frequency of implementation of each operation of the method 200 is specific thereto and is not necessarily related to the implementation of the other operations.

As illustrated in FIG. 6, the method 200 comprises an operation 210 of transmitting, by the first terminal 10a, to the second terminal 10b, a data stream of a push-to-talk communication on a specific push-to-talk transmission channel of the first network.

As illustrated in FIG. 6, the method 200 comprises an operation 220 of identifying, by the second terminal 10b, a specific push-to-talk broadcast channel of the second network associated with the specific push-to-talk transmission channel of the first channel. The second terminal 2b knows on which specific push-to-talk transmission channel of the first network the push-to-talk communication originating from the first terminal 10a is transmitted. Consequently, it is capable, for example from a pre-established look-up table, examples of which have already been described hereinabove, of identifying the specific push-to-talk broadcast channel of the second network corresponding to the specific push-to-talk broadcast channel of the first network.

As illustrated in FIG. 6, the method 200 comprises an operation 230 of transmitting, by the second terminal 10b, to the accessory 20, a signal indicating a start of data transmission and comprising an identifier of the specific push-to-talk broadcast channel of the second network. In this manner, the accessory 20 could reserve the specific push-to-talk broadcast channel in transmission.

As illustrated in FIG. 6, the method 200 comprises an operation 240 of transmitting, by the second terminal 10b, to the accessory 20, an audio signal corresponding to the data stream of the push-to-talk communication received from the first terminal 10a.

As illustrated in FIG. 6, the method 200 comprises an operation 250 of transmitting, by the accessory 20, to the third terminal 10c, a signal indicating a start of data transmission on the specific push-to-talk broadcast channel of the second network. This operation allows indicating to the third terminal 10c, that there will be a data stream of an audio signal, corresponding to a push-to-talk communication, to transmit on the specific push-to-talk communication channel of the second network so that the third terminal 10c could reserve this channel in transmission for the future transmission of this signal.

As illustrated in FIG. 6, the method 200 comprises an operation 260 of transmitting, by the accessory 20, to the third terminal 10c, the audio signal corresponding to the data stream of the push-to-talk communication emitted on the first network. Thus, the accessory 20 transmits an audio signal corresponding to the push-to-talk communication sent by the first terminal 10a to the second terminal 10b using the first network, to the third terminal 10c using the second network.

As illustrated in FIG. 7, the method 200 comprises an operation 270 of transmitting, by the third terminal 10c, to the fourth terminal 10d, a data stream of a push-to-talk communication corresponding to the audio signal received from the accessory 20, on the specific push-to-talk broadcast channel of the second network.

Consequently, the method 200 according to the present disclosure enables a user emitting a push-to-talk communication on a communication channel of an IP network to communicate with communication terminals connected to a corresponding communication channel belonging to a network different from the IP network, while ensuring talk management between the users specific to push-to-talk communications.

Optionally, other operations may be integrated into the method 200 and are described later on in the present disclosure. Unless stated otherwise, these operations may be integrated into the method 200 in combination with one another.

In some examples, the operation 220 of identifying, by the second terminal 10b, the specific push-to-talk broadcast channel of the second network associated with the specific push-to-talk transmission channel of the first network, may comprise:
selecting 221 a specific push-to-talk broadcast channel of the second network associated with the specific push-to-talk transmission channel of the first network in a pre-established look-up table.

In these examples, the second terminal 10b may have the memory 11 configured to store a look-up table associating push-to-talk transmission channels of the first network with push-to-talk broadcast channels of the second network. Thus, during reception of a data stream on a push-to-talk transmission channel of the first network, the second terminal 10b could identify to which broadcast channel of the second network this data stream should be transmitted. Hence, the second terminal 10b will be capable of transmitting to the accessory 20 a transmission start signal associated with an identifier of the specific push-to-talk broadcast channel of the second network.

In some examples, the method 200 may comprise an operation 252 of transmitting, by the third terminal 10c, a signal indicating a start of data transmission on the specific push-to-talk broadcast channel of the second network. The operation 252 allows reserving the specific channel of the second network in transmission for the second terminal 2b. To the extent that it is sent on the specific push-to-talk broadcast channel of the second network, this signal is transmitted in particular to the fourth terminal 10d, as shown in FIG. 7.

In some examples wherein the accessory 20 comprises a microphone 21 and a loudspeaker 22, prior to the operation 260 of transmitting the audio signal from the accessory 20 to the third terminal 10c, the method 200 may further comprise:
an operation 258 of converting the audio signal corresponding to the data stream of the push-to-talk communication into an audible signal broadcasted by the loudspeaker of the accessory 20; then
an operation 259 of converting the audible signal broadcasted by the loudspeaker 22 and captured by the microphone 21 of the accessory 20 into an audio signal.

In these examples, this consists in transmitting the audible signal of the push-to-talk communication broadcasted at first on the first network to the second network using the accessory 20 connected to the two networks as a broadcaster of the push-to-talk communication via its loudspeaker 22, for the user of the accessory 20, and as a recorder of the push-to-talk communication broadcasted by the loudspeaker 22 via the microphone 21 for the users of the second network.

In the examples comprising the operations 258 and 259, prior to the conversion operation 259, and subsequently to the operation 250 of transmitting, by the accessory 20, to the third terminal 10c, a signal indicating a start of data transmission, the method may further comprise:
an operation 253 of transmitting, by the third terminal 10c, to the accessory 20, a command for activating the microphone 21.

The operation 253 allows notifying the accessory 20 that the microphone 21 should be used to capture and then transmit the sound recorded thereby on the specific broadcast channel of the second network.

In examples wherein the method 200 comprises the operation 252, the operation 253 is advantageously implemented after step 252 so that a message that the microphone 21 of the accessory 20 starts to record, i.e. from the push-to-talk communication emitted on the first network and broadcast by the loudspeaker 22, could be transmitted directly on the specific push-to-talk broadcast channel of the second network.

In some examples, the method 200 may further comprise an operation 280 of transmitting, from the third terminal 10c, a signal indicating an end of transmission on the specific push-to-talk broadcast channel, when the audio signal of the push-to-talk communication is completed. To the extent that it is sent on the specific push-to-talk broadcast channel of the second network, this signal is transmitted in particular to the fourth terminal 10d, as shown in FIG. 7. Hence, the operation 280 allows clearing the specific push-to-talk broadcast channel to enable other users of the channel, in particular the user of the fourth terminal 1d in the exemplary system 1, to talk on this channel.

Like with the method 100, the described operations of the method 200 are imagined to be executed in real-time so that, as soon as the user of the first terminal 10a talks on the specific transmission channel, the transmission start signal may be transmitted, almost simultaneously, from the accessory 20 to the third terminal 10c which could reserve the specific broadcast channel of the second network for talking of the user of the first terminal 10a.

Moreover, the present disclosure covers a push-to-talk communication terminal 10 adapted to be connected to a communication accessory 20. The push-to-talk communication terminal that will be described hereinbelow corresponds to the second terminal 10b, in the above-described methods 100 and 200. Consequently, the operations performed by the terminal 10 described hereinbelow will have the same references as the corresponding operations described with reference to the methods 100 and 200 of FIGS. 4 and 6.

The push-to-talk communication terminal 10 may comprise the memory 11 configured to store a look-up table between push-to-talk transmission channels of the first network using the Internet protocol, and push-to-talk broadcast channels of a second network using a protocol different from the Internet protocol.

In first examples, the terminal 10 may be configured to perform the following first operations:
after reception of a signal, originating from the accessory 20, indicating a start of data transmission and comprising an identifier of a specific push-to-talk broadcast channel of the second network:
   determining 140 a specific push-to-talk transmission channel of the first network associated with the specific push-to-talk broadcast channel of the second network, from the identifier of the broadcast channel;
and after reception of an audio signal, originating from the accessory 20, corresponding to a push-to-talk communication emitted on the second network;
   sending 160 a data stream of a push-to-talk communication on the determined specific push-to-talk transmission channel of the first network, the data stream of the push-to-talk communication corresponding to the audio signal received from the accessory.

In the first examples, the terminal 10 may also be configured to perform at least one of the following first operations:
selecting 141 a specific push-to-talk transmission channel of the first network associated with the identifier of the specific push-to-talk broadcast channel of the second network in a pre-established look-up table;
sending 142 a signal indicating a start of transmission on the determined specific push-to-talk transmission channel of the first network;
sending 143 to the accessory 20, a command for recording from the microphone 21 of the accessory 20; or
sending 170 a signal indicating an end of transmission on the specific push-to-talk transmission channel, when the audio signal of the push-to-talk communication is completed.

It should be understood that the first examples correspond to the operations performed by the terminal 10 in the context of the method 100.

In second examples, which could be combined with the first examples, the terminal 10 may be configured to perform the following second operations:
after reception of a data stream of a push-to-talk communication on a specific transmission channel of the first network:
   determining 220 a specific push-to-talk broadcast channel of the second network associated with the specific push-to-talk transmission channel of the first network;
   sending 230 to the accessory 20, a signal indicating a start of data transmission and comprising an identifier of the specific push-to-talk broadcast channel of the second network; and
   sending 240 to the accessory 20, an audio signal corresponding to the data stream of the push-to-talk communication received on the specific transmission channel of the first network.

In the second examples, the terminal 10 may also be configured to perform the following second operation:
selecting 221 a specific push-to-talk broadcast channel of the second network associated with the specific push-to-talk transmission channel of the first network in a pre-established look-up table.

It should be understood that the second examples correspond to the operations performed by the terminal 10 in the context of the method 200.

To the extent that the second examples could be combined with the first examples, the terminal 10 could therefore implement operations described only in the first examples, operations described only in the second examples, or operations described in both first and second examples.

Hence, the particular configuration of the terminal 10 according to the present disclosure allows exchanging push-to-talk communications between two communication networks using different protocols.

The present disclosure further covers a communication accessory 20, adapted to be connected to a communication terminal of a first communication network and to a communication terminal of a second communication network, the communication terminal of the first network being configured to exchange data streams, corresponding to push-to-talk communications, on the first network using the Internet protocol; the communication terminal of the second network being configured to exchange data streams, corresponding to push-to-talk communications, on the second network using a protocol different from the Internet protocol.

The communication accessory 20 that will be described hereinbelow corresponds to the communication accessory 20 used in the above-described methods 100 and 200. Consequently, the operations performed by the accessory 20 described hereinbelow will have the same references as the corresponding operations described with reference to the methods 100 and 200 of FIGS. 4 and 6. It should also be noted that the communication terminal of the first network which is considered in connection with the accessory 20 described hereinbelow corresponds to the second terminal 10b of the methods 100 and 200 whereas the communication terminal of the second network which is considered hereinbelow in connection with the accessory corresponds to the third terminal 10c of the methods 100 and 200. The terminologies “first terminal” and “second terminal” has not been used again to avoid confusion with the first terminal 10a and the second terminal 10b belonging to the communication system of FIG. 1. Nonetheless, it would have been possible to use such terminologies instead of “communication terminal of a first network” and “communication terminal of a second network”.

In first examples, the accessory 20 may be configured to perform the following operation:
after reception of an audio signal corresponding to a data stream of a push-to-talk communication emitted on a specific broadcast channel of the second network, originating from the communication terminal of the second network:
   sending 130, to the communication terminal of the first network, a signal indicating a start of data transmission and comprising an identifier of the specific push-to-talk broadcast channel of the second network.

In first examples, the accessory 20 may also be configured to perform the following operation:
sending 150, to the communication terminal of the first network, an audio signal corresponding to the data stream of the push-to-talk communication received from the communication terminal of the second network.

In second examples, which could be combined with the first examples, the accessory 20 may be configured to perform the following operation:
after reception of a signal indicating a start of data transmission and comprising an identifier of the specific push-to-talk broadcast channel of the second network, originating from the communication terminal of the first network:
   sending 250, to the communication terminal of the second network, a signal indicating a start of data transmission and comprising an identifier of the specific push-to-talk broadcast channel of the second network.

In second examples, the accessory 20 may also be configured to perform the following operation:
after reception of an audio signal of a push-to-talk communication emitted on a specific transmission channel of the first network, originating from the communication terminal of the first network:
   sending 260, to the communication terminal of the second network, an audio signal corresponding to the data stream of the push-to-talk communication received from the communication terminal of the first network.

To the extent that the second examples could be combined with the first examples, the accessory 20 could therefore implement operations described only in the first examples, operations described only in the second examples, or operations described in both first and second examples.

Hence, the particular configuration of the accessory 20 according to the present disclosure allows exchanging push-to-talk communications between two communication networks using different protocols.

Thus, the present disclosure, according to its different variants, enables two groups of push-to-talk communication terminals, belonging to different communication networks, to communicate together, so that, from the perspective of the users of the terminals of the two communication groups, there is one single communication group. In particular, the electronic architectures and networks of the terminals have not been modified to enable the implementation of this solution. The configurations of a terminal and of a communication accessory of the communication system 1 may be modified and are enough to enable this operation, so that the proposed solution is inexpensive and barely complex to implement. In particular, existing terminals may be used without it being necessary to adapt them, neither structurally nor functionally.

1. A method for push-to-talk communication between at least four communication terminals;
at least one first communication terminal—and a second communication terminal being adapted to exchange with each other data streams, corresponding to push-to-talk communications, on a first communication network using the Internet protocol;
a third communication terminal and at least one fourth communication terminal being adapted to exchange with each other data streams, corresponding to push-to-talk communications, on a second communication network using a protocol different from the Internet protocol;
the second communication terminal and the third communication terminal being further connected to the same communication accessory;
the method comprising:
transmitting, by a fourth communication terminal, to the third communication terminal, a data stream of a push-to-talk communication, on a specific push-to-talk broadcast channel of the second network;
transmitting, by the third communication terminal, to the communication accessory, an audio signal corresponding to the data stream of the push-to-talk communication;
transmitting, by the communication accessory, to the second communication terminal, a signal indicating a start of data transmission and comprising an identifier of the specific push-to-talk broadcast channel of the second network;
identifying, by the second communication terminal, a specific push-to-talk transmission channel of the first network associated with the specific push-to-talk broadcast channel of the second network, based on the identifier;
transmitting, by the communication accessory, to the second communication terminal, the audio signal corresponding to the data stream of the push-to-talk communication;
transmitting, by the second communication terminal, to a first communication terminal, a data stream of a push-to-talk communication corresponding to the audio signal received from the communication accessory, on the specific push-to-talk transmission channel of the first network.

2. The method according to claim 1, wherein the communication accessory comprises a microphone and a loudspeaker,
and wherein, prior to the transmission, by the communication accessory, to the second communication terminal, of the audio signal corresponding to the data stream of the push-to-talk communication, the method further comprises:
converting the audio signal corresponding to the data stream of the push-to-talk communication into an audible signal broadcasted by the loudspeaker of the communication accessory; then
converting the audible signal broadcasted by the loudspeaker and captured by the microphone of the communication accessory into an audio signal.

3. The method according to claim 1, wherein the identifier of the specific push-to-talk broadcast channel of the second network corresponds to a frequency of the specific push-to-talk broadcast channel.

4. The method according to claim 1 any one of the preceding claims, wherein the identification, by the second communication terminal, of the specific push-to-talk transmission channel of the first network associated with the specific push-to-talk broadcast channel of the second network, comprises:
selecting a specific push-to-talk transmission channel of the first network associated with the identifier of the specific push-to-talk broadcast channel of the second network in a pre-established look-up table.

5. A method for push-to-talk communication between at least four communication terminals;
at least one first communication terminal—and a second communication terminal being adapted to exchange with each other data streams, corresponding to push-to-talk communications, on a first communication network using the Internet protocol;
a third communication terminal and at least one fourth communication terminal being adapted to exchange with each other data streams, corresponding to push-to-talk communications, on a second communication network using a protocol different from the Internet protocol;
the second communication terminal and the third communication terminal being further connected to the same communication accessory;
the method comprising:
transmitting, by a first communication terminal, to the second communication terminal, a data stream of a push-to-talk communication on a specific push-to-talk transmission channel of the first network;
identifying, by the second communication terminal, a specific push-to-talk broadcast channel of the second network associated with the specific push-to-talk transmission channel of the first network;
transmitting, by the second communication terminal, to the communication accessory, a signal indicating a start of data transmission and comprising an identifier of the specific push-to-talk broadcast channel of the second network;
transmitting, by the second communication terminal, to the communication accessory, an audio signal corresponding to the data stream of the push-to-talk communication;
transmitting, by the communication accessory, to the third communication terminal, a signal indicating a start of data transmission on the specific push-to-talk broadcast channel of the second network;
transmitting, by the communication accessory, to the third communication terminal, the audio signal corresponding to the data stream of the push-to-talk communication; and
transmitting, by the third communication terminal, to a fourth communication terminal, a data stream of a push-to-talk communication corresponding to the audio signal received from the communication accessory, on the specific push-to-talk broadcast channel of the second network.

6. A push-to-talk communication terminal adapted to be connected to a communication accessory;
the terminal being configured to perform first operations comprising:
after reception of a data transmission start signal, originating from the communication accessory, indicating a start of data transmission and comprising an identifier of a specific push-to-talk broadcast channel of a second network;
identifying a specific push-to-talk transmission channel of a first network associated with the specific push-to-talk broadcast channel of the second network, based on the identifier;
and after reception of an audio signal, originating from the communication accessory, corresponding to a push-to-talk communication emitted on the second network:
sending a data stream on the identified specific push-to-talk transmission channel of the first network, the data stream corresponding to the audio signal received from the communication accessory; or
the terminal being configured to perform second operations comprising:
after reception of a data stream of a push-to-talk communication on a specific transmission channel of a first network:
identifying a specific push-to-talk broadcast channel of the second network associated with the specific push-to-talk transmission channel of the first network;
sending, to the communication accessory, a signal indicating a start of data transmission and comprising an identifier of the specific push-to-talk broadcast channel of the second network; and
sending, to the communication accessory, an audio signal corresponding to the data stream of the push-to-talk communication received on the specific transmission channel of the first network.

7. The terminal according to claim 6, wherein:
the first operations further comprise at least one of the following operations:
selecting a specific push-to-talk transmission channel of the first network associated with the identifier of the specific push-to-talk broadcast channel of the second network in a pre-established look-up table;
sending a signal indicating a start of transmission on the determined specific push-to-talk transmission channel of the first network; or
sending a signal indicating an end of transmission on the specific push-to-talk transmission channel, when the audio signal of the push-to-talk communication is completed;
or the second operations further comprise:
selecting a specific push-to-talk broadcast channel of the second network associated with the specific push-to-talk transmission channel of the first network in a pre-established look-up table.

8. The terminal according to claim 6, wherein the terminal is configured to perform the first and second operations.

9. A communication accessory adapted to be connected to a communication terminal of a first communication network and to a communication terminal of a second communication network,
the communication terminal of the first network being configured to exchange data streams, corresponding to push-to-talk communications, on a first communication network using the Internet protocol;
the communication terminal of the second network being configured to exchange data streams, corresponding to push-to-talk communications, on a second communication network using a protocol different from the Internet protocol;
the communication accessory being configured to perform the following operation:
after reception of an audio signal corresponding to a data stream of a push-to-talk communication emitted on the specific broadcast channel of the second network, originating from the communication terminal of the second network:
sending, to the communication terminal of the first network, a signal indicating a start of data transmission and comprising an identifier of the specific push-to-talk broadcast channel of the second network; or
the communication accessory being configured to perform the following operation:
after reception of a signal indicating a start of data transmission and comprising an identifier of the specific push-to-talk broadcast channel of the second network, originating from the communication terminal of the first network:
sending, to the communication terminal of the second network, a signal indicating a start of data transmission and comprising an identifier of the specific push-to-talk broadcast channel of the second network.

10. The communication accessory according to claim 9, wherein the communication accessory being configured to perform the following operation:
after reception of an audio signal corresponding to a data stream of a push-to-talk communication emitted on the specific broadcast channel of the second network, originating from the communication terminal of the second network:
sending, to the communication terminal of the first network, a signal indicating a start of data transmission and comprising an identifier of the specific push-to-talk broadcast channel of the second network;
and wherein the communication accessory is further configured to perform the following operation:
after reception of a signal indicating a start of data transmission and comprising an identifier of the specific push-to-talk broadcast channel of the second network, originating from the communication terminal of the first network:
sending, to the communication terminal of the second network, a signal indicating a start of data transmission and comprising an identifier of the specific push-to-talk broadcast channel of the second network.
